(19) United States
(12) Patent Application Publication
(10) Pub. No.: US 2021/0162541 A1
(43) Pub. Date: Jun. 3, 2021

(54) SIMULATION METHOD FOR DEVELOPING A PRODUCTION PROCESS

(71) Applicant: MTU Aero Engines AG, Muenchen (DE)

(72) Inventors: Thomas Goehler, Dachau (DE); Tobias Maiwald-Immer, Muenchen (DE); Andreas Fischersworring-Bunk, Muenchen (DE)

(21) Appl. No.: 17/176,943

(22) Filed: Feb. 16, 2021

Related U.S. Application Data
(62) Division of application No. 15/528,810, filed on Nov. 7, 2017.

(30) Foreign Application Priority Data
Nov. 27, 2014 (DE) 10 2014 224 239.8

(51) Int. Cl. B23K 26/342; B23K 26/70; G06F 30/20; B33Y 30/00; B29C 64/153; B33Y 50/02; B33Y 10/00; G05B 19/4099; G06F 111/20

(52) U.S. Cl. CPC B23K 26/342; B23K 26/702; G06F 30/20; B33Y 30/00; B29C 64/153; G06F 2111/20; B33Y 10/00; G05B 19/4099; G05B 2219/49004; G05B 2219/35134; B33Y 50/02

(57) ABSTRACT

A method for developing a production process where a component is built up layer by layer by melting on powder material using a radiation source, and the melted-on powder material is subsequently solidified; in a first phase of the method, material-specific properties of a material being ascertained as a function of process parameters in a multiscale, physically based simulation chain independently of a component geometry; and, in a second phase of the method, taking into account the process parameters and the material-specific properties, an additive build-up of the component using this material being simulated which ensures minimal distortions and internal stresses. Also described is an installation for the generative production of components that includes a processing unit that is adapted for implementing a method for developing a production process.

This is a Divisional of U.S. Ser. No. 15/528,810, filed Nov. 11, 2017, which is a National Phase Application of PCT/DE2015/000526, filed on Oct. 31, 2015, which claims the benefit of German Patent Application DE 102014224239.8, filed on Nov. 27, 2014, all of which have been incorporated by reference herein.

The present invention relates to a method for developing a production process where a component is built up layer by layer by using a radiation source to melt on powder material, and the melted-on powder material is subsequently solidified. The present invention also relates to an installation for additively manufacturing components.

### BACKGROUND

Complex components can be directly created from a computer model using additive production processes, also known as “rapid prototyping” or “additive manufacturing.” A widely used additive production process is beam melting. In beam melting, the component is built up layer by layer by melting on powder material using a radiation source and by subsequently solidifying the melted-on powder material. The powder material is generally metal-based, and a laser or an electron beam is used as a radiation source.

Interactions between chemical compositions of the powder material, manufacturing parameters and final properties of the particular component are determined empirically. However, the empirical determination entails considerable time and expense. When individual parameters deviate in one step of the production chain, it is not possible to quantify the effects of these deviations on subsequent steps. This makes it difficult to assess deviations and limits further developments, such as the use of alternative materials and other process parameters.

The U.S. Patent Application 20100174392 A1 describes a method for improving production parts manufactured by rapid prototyping. For this purpose, suitable material is used, and an input data record and an information record containing information pertaining to production factors are accessed that are included in a preceding production run for one production part. The method includes executing a production run that produces output components; comparing the output components to the input data record to generate a resulting data record; the resulting data record containing deviations between the input data record and the output components; integrating the resulting data record into the information record; and adapting the information record to reduce the deviations between the input data record and the output components in comparison to at least one preceding production run. The output components include a combination of at least one production part and at least one iterative improvement test piece; the iterative improvement test pieces including z tensile arrays, density cubes, dimensional pyramids, flexural samples or combinations thereof.

### SUMMARY OF THE INVENTION

It is an object of the present invention to provide a technique/methods for rapidly and reliably developing an additive production of a component.

In a method according to the present invention for developing a production process where a component is built up layer by layer by melting on powder material using a radiation source, and the melted-on powder material is subsequently solidified, material-specific properties of a material are ascertained in a first phase of the method as a function of process parameters independently of a component geometry in a multiscale simulation chain. An additive build-up of the component using this material is simulated in a second phase of the method, taking into account the process parameters and the material-specific properties.

A storage medium according to the present invention or a plurality thereof contains/contain machine-readable instructions, which, when executed by a computer, implement a method according to the present invention in accordance with one of the specific embodiments described in this document.

An installation according to the present invention for additively manufacturing components includes a device for melting on powder material layer by layer using a radiation source, as well as a processing unit (respectively, a computer) that is adapted for implementing a method according to the present invention in accordance with one of the specific embodiments described in this document; for generating a computer model for a component to be manufactured in the particular case in the second phase of the method; and for controlling the device for melting on powder material layer by layer on the basis of the generated computer model.

The simulation method according to the present invention enables an integrated assessment of the production chain and, in particular, a multiscale, interdisciplinary physical approach. This makes it possible to reliably develop a production process, respectively a process chain. A physically based modeling thereby takes place in the first phase of the method, and a phenomenological modeling in the second phase of the method. Prior to the actual additive manufacturing of the component, it is possible to ascertain whether the components have the load-oriented nominal requirements thereof defined in the computer model or whether there are deviations therefrom. It is possible to significantly reduce the scope of the time-consuming and costly trials performed on and testing of the manufactured component. In other words, the inventive simulation method permits a process development by defining potential useful parameters/parameter windows for new generations of installations, installation parameters, materials, and the like. A specific component geometry and scan strategy are defined and optimized for additively manufactured components for a near net shape production. In the course of a sensitivity and deviation assessment, deviations from the defined production process are analyzed and assessed; deviations of this kind are preferably at least partially automatically recognized by a/the computer. The consequences of the deviations on the properties and quality of the component may be shown on a display unit, for example, on a screen display, in particular. Targeted experiments, which are made possible by comprehensive simulation results, reduce the outlay for process development and sensitivity studies, and for assessing deviations. In addition, sizes and effects, which are difficult to analyze, are rendered assessable, respectively accessible.

In the second phase of the method, simulating the additive build-up preferably includes generating a computer model of the additive build-up of the component using at least one computer.

A method according to the present invention for manufacturing a component includes implementing a method for developing a production process in accordance with one of the specific embodiments described in this document, the simulation including generating the additive build-up of the component in a computer. A method of this kind also includes a third phase of the method where powder material is melted on layer by layer using a radiation source, and the melted on powder material is subsequently solidified in accordance with the generated computer model.

A multiscale, physically based simulation chain is absolutely required to correctly and proficiently carry out the above described process development, as well as the sensitivity and deviation assessment.

Here, a simulation chain means coupling simulation methods that are mutually dependent or that build on one another.

Here, physically based means that the individual models or methods, or the coupling thereof correctly describe/describes the dominating, process-relevant physical effects using suitable approaches based on material-physical input data.

Multiscale here means that the models or methods must describe individual effects on corresponding and different size scales and time scales based on the results from the physical approach.

Only upon coupling of the individual methods, is it possible to integrally describe the process-relevant effects for the additive method, and characterize the influence of process and process parameters on the material properties and the resulting local material strength.

The first method step includes this multiscale, physically based simulation chain composed of the following five steps for linking the manufacturing process to the microstructure and local material strength.

The first phase of the method includes linking the following five steps to a simulation chain:

a)—ascertaining a temperature field on the basis of a melt pool movement and a melt pool solidification curve;
b)—ascertaining a local solidification rate on the basis of the temperature field and resulting segregations;
c)—ascertaining a grain structure of the material on the basis of the temperature field and the solidification rate;
d)—ascertaining a precipitate structure of the material on the basis of the temperature field, the grain structure, and a thermal treatment; and
e)—ascertaining local, mechanical properties on the basis of the temperature field, the grain structure, and the precipitate structure.

In first step a), for example, an energy input and the particular material are defined, and a melt pool dynamics and melt pool solidification are then computed taking into account the energy input and the selected material. The temperature field is numerically computed on the basis of data defined and/or computed in this manner (for the energy input and the particular material). A lattice Boltzmann method is preferably used; inter alia, it makes possible viewing planes of approximately 1 mm².

In second step b), a local dentritic, rapid solidification is ascertained on the basis of the temperature field/temperature gradients from first step a). Moreover, a segregation or chemical inhomogeneity is ascertained on the basis of the temperature field/temperature gradients. The particular computation is preferably performed only for various small increments of first step a) using the phase field method.

In third step c), a cellular automaton (CA) is used to compute a grain structure (morphology, such as grain size and elongation ratio, as well as texture) resulting from the parameters and temperature fields identified as expedient in first step a), as well as from the solidification rates from step b).

Fourth step d) computes a precipitation kinetics under the influence of the parameter window and temperature field from first step a), the grain structure from third step c), and the thermal treatment subsequent to a production process. A suitable method here is a CALPHAD based approach, implemented, for example, using a Kampmann-Wagner algorithm.

In fifth step e), a computation of local strength in terms of crystal physical properties is performed for expediently identified parameters from steps a) through d).

The second phase of the method preferably includes a sixth step 0 for simulating internal stresses and/or deformation in the component to be manufactured. An abstract computation of the additive manufacturing process is performed including an abstract layer-by-layer heat input and simplified material laws for describing the strength and deformation of the component to be manufactured.

The process parameters optimized in sixth step f) are preferably fed back to the first phase of the method and thus to the user of the particular installation, respectively to a design department. The feedback makes it possible to optimize the process development, respectively component manufacturing in the sense of altered scanning parameters and/or scan strategy for achieving minimal internal stresses and distortions.

A viewing plane in second step b) may be smaller than a respective viewing plane in both steps a) and c). Reasonable computational effort is expended to hereby obtain a good result. In second step b), a larger viewing plane in the mm² or mm³ range, for example, is also conceivable in principle; however, this requires suitable, high-capacity computer systems. The viewing planes are preferably equal in size in first and third steps a) and c).

A viewing plane in sixth step f) may be greater than in preceding steps a) through e). The larger viewing plane, for example, in the cm³ range, and the models used make it possible for the size of the component to be considered, allowing the simulation to be run through much faster.

A method according to the present invention is preferably at least partially implemented by a computer. In particular, some or all of the computations in steps a)-f) are preferably performed by a computer.

### BRIEF DESCRIPTION OF THE DRAWINGS

Preferred exemplary embodiments of the present invention will be described in greater detail below with reference to the drawings. It is understood that the schematically illustrated individual elements and components may be combined and/or designed in ways other than those described, and that the present invention is not limited to the variants presented.

Schematically, in the drawings,

FIG. 1: shows a greatly simplified flow chart of an exemplary method according to the present invention; and

FIG. 2 illustrates an installation according to the present invention.

### DETAILED DESCRIPTION

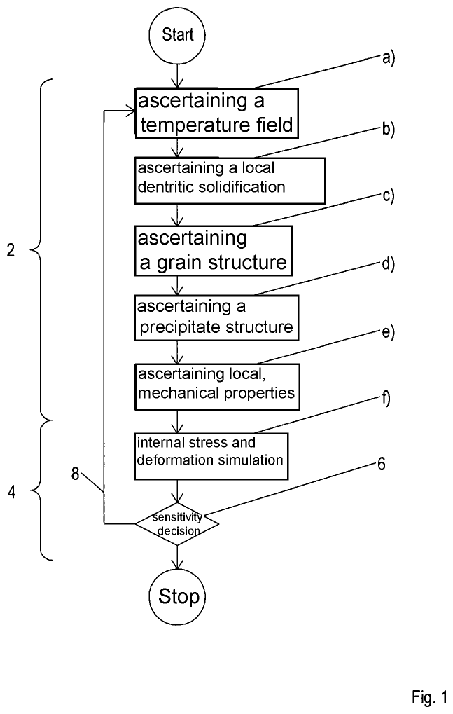

FIG. 1 shows method 1 according to the present invention on the basis of a greatly simplified flow chart. It is intended that a component be additively manufactured layer by layer by melting on powder material using a radiation source, and that the melted-on powder material be subsequently solidified. The powder material is metal-based, for example, and a laser is used as a radiation source. It is intended that a production process for additively manufacturing the component with optimal strength properties be developed prior to the physical manufacture of the component. To this end, specific properties of a material are ascertained in a first phase 2 of the method as a function of process parameters, independently of a component geometry. In a second phase 4 of the method, a component is then built up using this material, taking into account the process parameters and the specific properties.

The first phase of the method includes a multiscale, physically based modeling. In the exemplary embodiment shown here, it includes the following five steps:

a)—ascertaining a temperature field on the basis of a melt pool movement and a melt pool solidification curve;
b)—ascertaining a local dentritic solidification rate on the basis of the temperature field;
c)—ascertaining a grain structure of the material on the basis of the temperature field and the solidification rate;
d)—ascertaining a precipitate structure of the material on the basis of the temperature field, the grain structure, and a thermal treatment; and
e)—ascertaining local, mechanical properties on the basis of the temperature field, the grain structure, and the precipitate structure.

The five steps a) through e) optimize the process parameters and the material for the optimal strengths of the base material as a function of specific requirements placed on the macroscopic component or on individual component zones.

A component geometry and scan/manufacturing strategy of the additive manufacturing are optimized to minimize internal stresses and distortions to enable near net shape manufacturing.

In first step a), parameters, such as energy, scanning rate, layer thickness are derived and identified, via which a high volume density in the component and a negligible roughness in the boundary contour may be achieved or ensured. A viewing plane is preferably approximately 1 mm².

In second step b), material-specific, dendritic solidification rates are ascertained as a function of the thermal conditions, such as the temperature field and temperature gradient field from first step a), segregation coefficients and the like for the individual elements on the basis of the computation results from step a) mentioned in the preceding phase. Here, the phase field method may be used, for example. A viewing plane preferably ranges from nm² to μm² or nm³ to μm³.

A local rapid solidification is ascertained on the basis of the temperature field/temperature gradients from first step a). Moreover, a segregation or chemical inhomogeneity is ascertained on the basis of the temperature field/temperature gradients. The particular computation is preferably only performed for various small increments of first step a).

In third step c), it is ascertained which grain structure (morphology, such as grain size and elongation ratio, as well as texture) may be achieved using the respective, specific energy source and the selected/potential parameters, respectively may be attained in the potential parameter window. Examples are a columnar or rod-shaped grain structure or a globulitic grain structure, respectively an equioriented grain structure. Further examples include graded transitions between both grain structures that may be selectively adjusted in different zones of the component in order to satisfy the particular strength requirements. Third step c) is preferably achieved using the cellular automaton method. A viewing plane is preferably approximately 1 mm² and thus within the range of the preferred viewing plane of first step a). The computation results from first step a) and second step b) mentioned in the preceding section form the basis.

Fourth step d) ascertains which particle sizes, proportion by volume, and which phases exist at all following the process, and what influence the thermal treatment has on the development thereof. A suitable method in this case is a CALPHAD based method for describing thermokinetic precipitation reactions. This method allows viewing planes in the preferred range of nm³ to 1 mm². However, a viewing plane larger than 1 mm² is also conceivable. A precipitation kinetics under the influence of the parameter window and temperature field from step a), the grain structure from step c), and the thermal treatment subsequent to a production process are computed.

In fifth step e), local strengths are derived from the grain structure (morphology and texture) and precipitation state (particle size, volumetric proportion of the phase, and the like) for different component regions. A crystal plasticity method may be used to model fifth step e). A viewing plane is preferably in the mm³ range. A computation of the local strength in crystal physical terms is performed for all possible and useful combinations from the preceding four steps a) through d).

Second phase 4 of the method relates to the modeling of the component plane. It includes a sixth step f) in which an internal stress simulation and a deformation are carried out in the component to be manufactured on the basis of material models. In sixth step f), internal stresses and distortions that result from the process are computed using the input from the scan strategy stored in the build order. Optimization measures are derived for the component geometry, scan strategy and the like to reduce internal stresses and distortions and to make possible a near net shape production. In sixth step f), a viewing plane is preferably in the cm³ range and is thus larger than in preceding steps a) through e).

Here, second phase 4 of the method has an interface to first step a); and, more specifically, the abstract thermal coupling, respectively the alternative heat source used from method step 4 may be calibrated and optimized using the data from the highly resolved, physically based melt pool simulation from step a), without any further experimental outlay. In addition, the second phase of the method has an interface to fifth step e); and, more specifically, the calibration of the simplified material laws stored or used in phase 4 of the method on the basis of the highly resolved, physically based local strength calculation from step e). In other words: it is the aim of the interface to improve the abstract, simplified models using steps a) and e).

As a function of a sensitivity decision, respectively a deviation assessment 6, a feedback 8 of parameters may take place from second phase 4 of the method to first phase 1 of the method and, thus, to the user of the particular installation, respectively to a design department. The process development may be hereby constantly optimized.

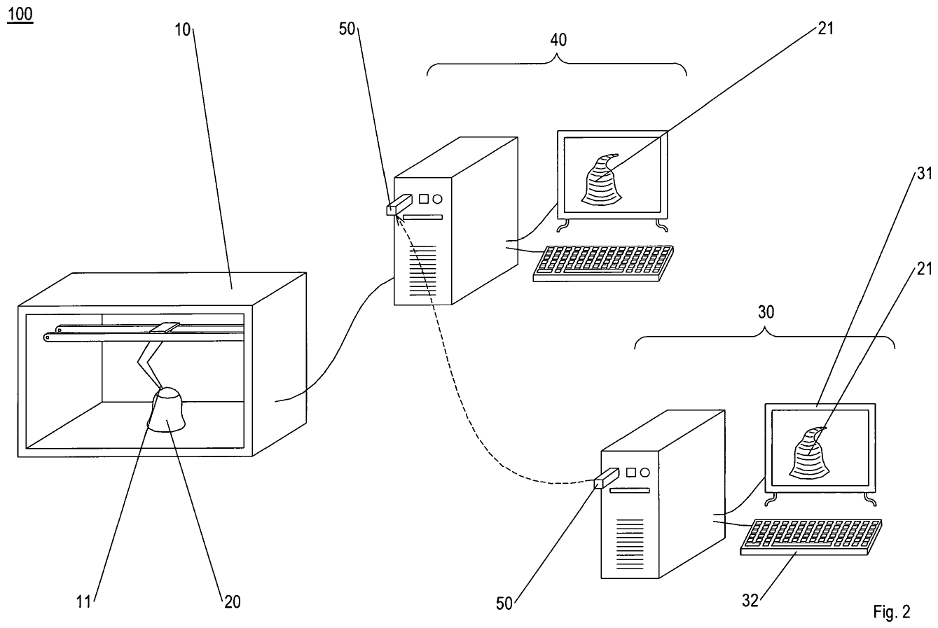

FIG. 2 is an exemplary specific embodiment of an inventive installation 100 for additively manufacturing components. The illustrated installation includes a device 10 for melting on powder material layer by layer using a radiation source 11 in order to manufacture a component 20 in this way. Furthermore, installation 100 includes a processing unit (respectively, a computer) 30 that is adapted for implementing a method according to the present invention to develop a production process in accordance with one of the specific embodiments described in this document and for thereby simulating, in particular, an additive building up of the component. Illustrated processing unit 30 includes a screen display 31 for displaying a computer model 21 of component 20 generated in the course of the simulation. Parameters, such as the particular material and/or an energy input, may be specified via input means 32.

Processing unit 30 is preferably adapted to ascertain whether defined, load-oriented, nominal requirements suffice for computer model 21 prior to manufacture of component 20, or whether there are deviations therefrom, as well as to display consequences, potentially resulting from the deviations, for the properties and quality of the component, for example, on screen display 31.

In the illustrated example, data determining the generated computer model are stored on a mobile data carrier 50 and thus transmitted to a processing unit 40 that is associated with device 10. Alternatively, the data could be transmitted via a wireless communication connection or via a data transmission cable from processing unit 30 to processing unit 40. Processing unit 40 is adapted for controlling device 10 for melting on powder material layer by layer on the basis of generated computer model 21.

In accordance with an alternative specific embodiment, a processing unit 30 that carries out an inventive method (for simulating, in particular, the additive building up of the component) is connected to device 10 to melt on powder material layer by layer (wirelessly or via a data transmission cable) and adapted for controlling the melting on of powder material on the basis of generated computer model 21. Thus, the need for a second, external processing unit is eliminated in accordance with this specific embodiment.

Instructions for implementing the method according to the present invention may be stored on a machine-readable medium, for example, and be made available to a processing unit of this kind linked to device 10.

A method is described for developing a production process where a component is built up layer by layer by melting on powder material using a radiation source, and the melted-on powder material is subsequently solidified; in a first phase of the method, material-specific properties of a material being ascertained as a function of process parameters independently of a component geometry in a multiscale, physically based simulation chain; and, in a second phase of the method, taking into account the process parameters and the material-specific properties, an additive build-up of the component using this material being simulated, which ensures minimal distortions and clampings internal stresses. Also described is an installation for manufacturing a component that includes a processing unit that is adapted for implementing a method for developing a production process, and a device for melting on powder material layer by layer using a radiation source on the basis of a computer model generated in the course of the method.

### LIST OF REFERENCE NUMERALS

1 method
2 first phase of the method
4 second phase of the method
6 sensitivity decision, respectively deviation assessment
8 feedback
a) ascertaining a temperature field
b) ascertaining a local dentritic solidification rate
c) ascertaining a grain structure
d) ascertaining a precipitate structure
e) ascertaining local, mechanical properties
f) internal stress and deformation simulation
10 device for melting on powder material layer by layer
11 radiation source
20 component
21 computer model
30 processing unit
31 screen display
32 input means
40 processing unit
50 data carrier
100 installation for additively manufacturing components

1-13. (canceled)

14: A method for manufacturing a component comprising:
in a first phase, only ascertaining material-specific properties of a material as a function of process parameters independently of a geometry of the component in a multiscale simulation chain; and,
in a second phase, taking into account the process parameters and the material-specific properties of the first phase, performing a simulation of an additive build-up of the component using the material to generate a computer model of the additive build-up of the component;
in a third phase, melting on powder material layer by layer using a radiation source, and subsequently solidifying the melted-on powder material in accordance with the generated computer model.

15: The method as recited in claim 14 wherein the method is at least partially implemented by a computer.

16: The method as recited in claim 14 wherein the first phase of the method includes:
a)—ascertaining a temperature field on the basis of a melt pool movement and a melt pool solidification curve;
b)—ascertaining a local solidification rate on the basis of the temperature field and segregations;
c)—ascertaining a grain structure of the material on the basis of the temperature field and the local solidification rate;
d)—ascertaining a precipitate structure of the material on the basis of the temperature field, the grain structure, and a thermal treatment; and
e)—ascertaining local, mechanical properties on the basis of the temperature field, the grain structure, and the precipitate structure.

17: The method as recited in claim 16 wherein the second phase includes a sixth step (f) in which internal stresses, respectively distortions or deformations, are simulated in the component to be manufactured on the basis of material models.

18: The method as recited in claim 17 wherein process parameters optimized in sixth step (f) are fed back to the first phase.

19. The method as recited in claim 16 wherein a viewing plane in second step (b) is smaller than other viewing planes in first step (a) and third step (c).

20. The method as recited in claim 18 wherein a viewing plane in sixth step (f) is greater than in preceding steps (a) through (e).

21: An installation for additively manufacturing components, the installation comprising:
a device for melting on powder material layer by layer using the radiation source; and
one or more processing units adapted for implementing the method as recited in claim 14.
